(19) United States
(12) Patent Application Publication
(10) Pub. No.: US 2006/0100877 A1
(43) Pub. Date: May 11, 2006

(54) Generating and relating text to audio segments

(75) Inventors: Long Zhang, Beijing (CN); Li Ping Yang, Beijing (CN); Shi Xia Liu, Beijing (CN); Yong Qin, Beijing (CN)

Correspondence Address: John E. Campbell;IBM Corporation, 2455 South Road, P386, Poughkeepsie, NY, 12601, US

(73) Assignee: International Business Machines Corporation, Armonk, NY (US)

(21) Appl. No.: 11/268,367

(22) Filed: Nov. 7, 2005

(30) Foreign Application Priority Data
Nov. 11, 2004 (CN) 2004100946611

(51) Int. Cl. G10L 13/08

(52) U.S. Cl. 704/260

(57) ABSTRACT

A method, apparatus and system for generating speech minutes. The method comprises the steps of displaying status indicators of respective audio (speech) stream chunks received and text information thereof on a GUI display and establishing the tagging between each audio stream chunk and the corresponding text information by dragging and dropping the status signs of the respective speech stream chunks onto the corresponding text information on the GUI, such that the speech stream, the text information and the corresponding tagging relation form voice tagged meeting minutes.

### TECHNICAL FIELD OF THE INVENTION

The application relates generating speech meeting minutes, and particularly to a method, apparatus and system for generating voice tagged meeting minutes by conducting a drag-and-drop action on a graphical interface.

### BACKGROUND OF THE INVENTION

Documenting meetings can be an important part of organizational activities. Meeting minutes constitute a portion of all the related records of a meeting. They capture the essential information of the meeting, such as decisions and assigned actions. Right after the meeting, it is usual for someone to look at the meeting minutes to review and act on decisions. Attendees can be kept clear about their working focus by being reminded of their roles in a project and by clearly defining what happened in the meeting. Even during the meeting, it is helpful to refer to something from a point earlier in the meeting, for example, asking a question that pertains to a certain part of the content of a previous lecture.

Typically, meeting minutes are taken on paper by a meeting note taker, revised and sent out to all the related members (or by email). Revision is a tedious process, because it is very difficult to record everything during the meeting, and the note taker often needs the people attending the meeting to clarify what was said, needs to obtain information that was shown on a slide, or needs to check whether the spelling of names and/or the spelling of technical terminology are right.

In order to improve the efficiency of taking meeting minutes, several note-taking systems based on speech (audio) recording are developed. Rough'n'Ready system (refer to F. Kubala, S. Colbath, D. Liu, A. Srivastava, and J. Makhoul. Integrated Technologies for Indexing Spoken Language., Communications of the ACM, vol. 43, no. 2, pp. 48, February 2000 incorporated herein by reference) is a prototype system that automatically creates a rough summarization of a speech that is ready for browsing. Its aim is to construct a structural representation of the content in the speech, which is very powerful and flexible as an index for content-based information management, but it did not solve the problem of retrieving audio according to the recorded documents. Marquee system (refer to Weber, K., and Poon, A. Marquee: A Tool for Real-Time Video Logging. Proceedings of CHI '94(Boston, Mass., USA, April 1994), ACM Press, pp. 58-64 incorporated herein by reference) is a pen-based logging tool which enables to correlate users' personal notes and keywords with a videotape during recording. It focused on creating an interface to support logging, but did not resolve the issues of retrieving video from the created log. Efforts in CMU system (refer to Alex Waibel, Michael Bett, Florian Metze, Klaus Ries, Thomas Schaaf, Tanja Schultz, Hagen Soltau, Hua Yu, and Klaus Zechner. Advances in Automatic Meeting Record Creation and Access. Proceedings of ICASSP 2001, Seattle, USA, May 2001 incorporated herein by reference) have been focused on the completeness and accuracy of automatic meeting records creation and access, which retain the qualifications such as emotions, hedges, attention and precise wordings.

Further, the U.S. patent application No. US2003/0033161A1 incorporated herein by reference discloses a method and apparatus for recording a speech of a person being interviewed and providing interested people with an interview record for charge by using the manner of issuing related questions on the Internet.

Audio recording is an easy way to capture the content of meetings, group discussions, or conversations. However, it is difficult to find specific information in audio recordings because it is necessary to listen sequentially. Although it is possible to fast forward or skip around, it is difficult to know exactly where to stop and listen. On the other hand, the text meeting minutes can capture the essential information of a meeting, and allow the user to easily and quickly browse the content of the meeting, but the recorded content is difficult to ensure the recording of all details in the meeting, and sometimes some key points are even missing. For this reason, effective audio browsing requires the use of indices (such as text information) providing some structural arrangement to the audio recording.

### SUMMARY OF THE INVENTION

In order to solve the above problem, an object of the present invention is to provide a novel method, apparatus and system for correlating a speech audio record with text minutes. (which may be manually inputted) to generate voice tagged meeting minutes. The present invention can tag the speech record (speech chunk) to the text meeting minute through the speech segmentation and connection (for example, through a drag-and-drop action or other methods).

According to one aspect of the present invention, there is provided a method for generating speech minutes, comprising the steps of: displaying status signs of respective speech stream chunks inputted from outside and text information thereof on a GUI; and establishing the tagging between each speech stream chunk and the corresponding text information, such that the speech stream, the text information and the corresponding tagging relation form voice tagged meeting minutes.

According to another aspect of the present invention, there is provided a method for generating speech minutes, comprising the steps of: dividing a speech stream inputted from outside into at least two chunks and displaying status signs of the respective speech stream chunks and text information thereof on a GUI; and establishing the tagging between each speech stream chunk and the corresponding text information, such that the speech stream, the text information and the corresponding tagging relation form voice tagged meeting minutes.

According to another aspect of the present invention, there is provided a apparatus for generating speech minutes comprising: a GUI for displaying status signs of respective speech stream chunks inputted from outside and text information thereof; and a speech tagging means for establishing the tagging between each speech stream chunk and the corresponding text information, such that the speech stream, the text information and the corresponding tagging relation form voice tagged meeting minutes.

According to another aspect of the present invention, there is provided a apparatus for generating speech minutes comprising: a speech segmentation means for dividing a speech stream inputted from outside into at least two chunks; a GUI for displaying status signs of the respective speech stream chunks and text information thereof; a speech tagging means for establishing the tagging between each speech stream chunk and the corresponding text information, such that the speech stream, the text information and the corresponding tagging relation form voice tagged meeting minutes.

According to another aspect of the present invention, there is provided a system for generating speech minutes, the system comprising a recording device and a reproducing device, wherein the recording device comprises: a speech segmentation means for dividing a speech stream inputted from outside into at least two chunks; a first GUI for displaying status signs of the respective speech stream chunks and text information thereof; and a speech tagging means for establishing the tagging between each speech stream chunk and the corresponding text information when receiving a command of dragging and dropping the status signs of the respective speech stream chunks onto the corresponding text information on the GUI, such that the speech stream, the text information and the corresponding tagging relation form voice tagged meeting minutes.

By using the voice tagged meeting minutes of the present invention, it will be much easier to locate important points contained in a long time meeting, so as for readers to get easily the key points of the meeting, instead of reading the dry and impalpable text minutes or listening to the whole speech record. Therefore, it will save the user's time and energy greatly.

### BRIEF DESCRIPTION OF THE DRAWINGS

The features and advantages of the present invention as well as the structure and operation thereof can be best understood through the preferred embodiment of the present invention described in conjunction with the drawings, in which:

FIG. 1 is a schematic diagram showing the process of generating voice tagged meeting minutes according to the present invention, in which the speech chunks and manually inputted text minutes are integrated (correlated or tagged);

FIG. 2 is an overview of the meeting minutes recording system, in which the content displayed on the graphical interface of the present invention is shown in further details;

FIG. 3 is a block diagram showing the architecture of the voice tagged meeting minutes recording system according to the present invention.

FIG. 4 shows a flow chart of the process performed according to the present invention;

FIG. 5 shows how to stick a piece of speech chunk with a specific note point in the text minutes;

FIG. 6 indicates that after the drag-and-drop action, the note point is highlighted; and

FIG. 7 shows a case of playing the meeting minutes.

### DESCRIPTION OF THE PREFERRED EMBODIMENTS

In the present invention, a speech segmentation technique is used to automatically segment a speech stream (audio stream) into several speech chucks (audio chunks), such as the speech chunks belonging to different speakers. In the above mentioned Marquee system, the CMU system and the following document (D. Kimber, L. Wilcox, F. Chen, and T. P. Moran. Speaker Segmentation for Browsing Recorded Audio. Proceedings of CHI Conference Companion: Mosaic of Creativity, May 1995, ACM. incorporated herein by reference), much work has been done on the speech segmentation, and experiments showed that the current state of the technology can afford practical usage. Therefore, the present invention will not describe it in further details.

The apparatus, method and system of the invention will be described hereinafter in details in conjunction with drawings.

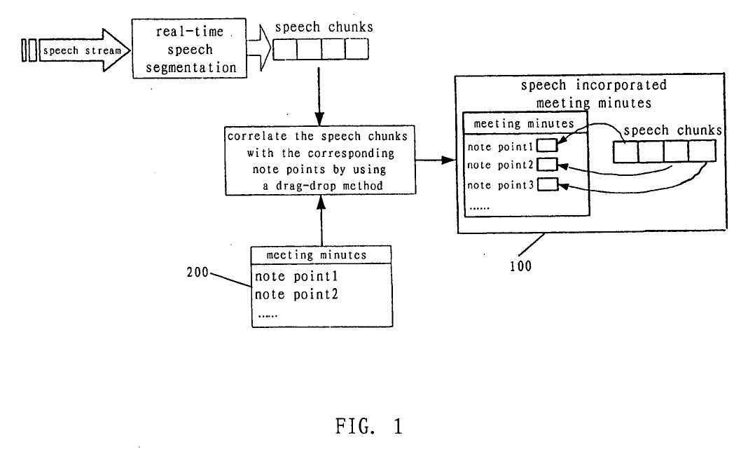

FIG. 1 is a schematic diagram showing the integration of speech chunks and manually inputted text minutes according to an embodiment of the present invention.

As shown in FIG. 1, when a meeting is going on, a speech stream (audio stream) is recorded on a speech recording device (speech track) of the apparatus of the present invention, then sent to a “real-time speech segmentation” module. The task of the module is to segment the speech stream into several speech chunks (for example, we assume herein each speech chunk corresponds to only the speech from a single speaker). These speech chunks are displayed on a graphical interface in a form of status signs (visual status indicators) to facilitate browsing and navigation. For example, as shown in the block 100 of FIG. 1, an example layout of the GUI is shown, in which the segmented speech chunks (four chunks are shown in the FIG. 1) are shown on the right of the GUI. The above status signs show the length and/or the type of the speech stream, which can be bar-shape chunks displayed in different colors or different brightness.

Pauses or silence intervals in a speech, such as the pause time during the speech of a speaker, as well as non-speech sounds, such as laughter, can also be segmented for use.

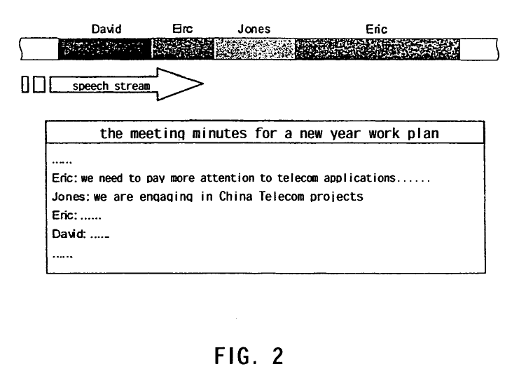

When a meeting logger writes a meeting minute by an inputting means as shown in the lower block 200 in FIG. 1, he can use the above mentioned graphical interface to browse the speech chunks of the meeting. It is preferred in the present invention that the GUI showing the status signs of the speech chunks and the GUI showing the inputted text meeting minutes are two different areas of the same GUI, as shown in FIG. 2. Assume that a speaker, such as Eric, is talking about “telecom projects”, the speech segmentation module separates his speech from the speech of the previous and the following speakers on the fly to form different parts, and displays one or more speech chunks output from the speech segmentation module on the graphical interface (the number of the speech chunks depends on the segmentation algorithm), which includes Eric's speech chunk. At the same time, the logger writes down a note point as “Eric: We should pay more attention to the telecom applications”, as shown in FIG. 2.

Then, on the graphical interface, the logger drags and drops the status signs of the respective speech chunks onto the note points corresponding thereto (as shown by the curves and arrows in the block 100 on the right of FIG. 1). In this way, a full voice tagged meeting minute will be generated by using the drag-and-drop method to correlate the segmented speech chunks with the corresponding minutes. When a reader reads the minutes, he can also listen to the related speech records for each note point instantaneously.

FIG. 2 is an overview of the meeting minutes recording system according to the present invention, in which the content displayed on the graphical interface of the present invention is shown in further details.

As shown in FIG. 2, the upper bar is a status presentation (a visual status sign) of the speech recording during the meeting. The recording also shows the result of the speech segmentation. The bar starts to appear from the left when the meeting begins. As the meeting procedes and the speech recording increases content, the bar extends to the right continuously, and displays the situation of the speech segmentation according to the development of the speech segmentation, i.e., shows the segmentation in different colors or brightness, or different shapes and etc. (that is, it is displayed as different speech chunks).

As can be seen in FIG. 2, the speech contents of different speakers such as David, Eric and Jones are divided into different chunks, each chunk being highlighted, wherein the part in the deepest color represents David's speech chunk (speech content), the part in a weak color (two chunks—i.e. there are two speeches) represents Eric's speech chunks, and the part in the weakest color represents Jones' speech chunk. Of course, as mentioned above, the different speech chunks can also be represented by other methods well known by those skilled in the art, such as in different colors (red, green, blue and etc.) or different shapes.

The lower part in FIG. 2 is an editing area for recording minutes. As seen in the Figure, the minute which is recorded when Eric first spoke is “we need to pay more attention to the telecom applications”, the recorded Jones' speech minute is “we are engaging in China Telecom projects”, and so on. A heading of the meeting minutes, such as “the meeting minutes for a new year work plan” can also be shown for example on the top part of the editing area.

The architecture of the voice tagged meeting minutes taking system according to the present invention as well as the process for generating the voice tagged meeting minutes will be described in details hereinafter in conjunction with the drawings, and then the case of playing time will be described.

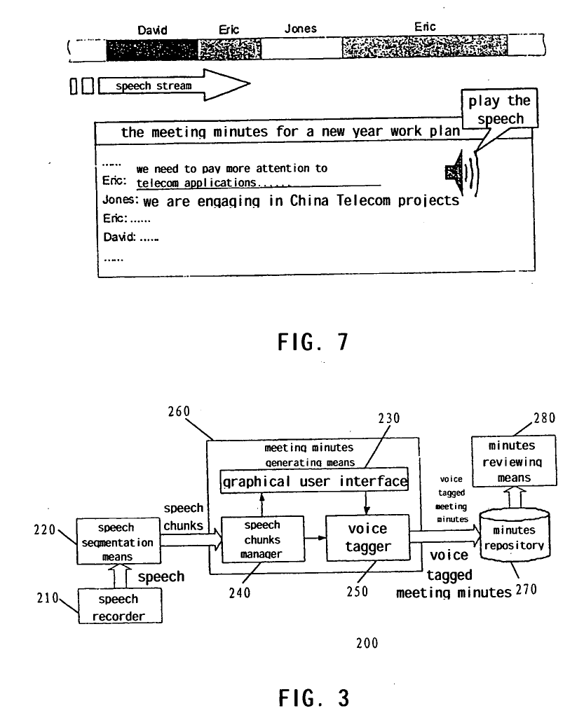

FIG. 3 is a block diagram showing the architecture of the voice tagged meeting minutes taking system according to the present invention.

As shown in FIG. 3, the voice tagged meeting minutes taking system 200 according to the present invention comprises: a speech recorder 210 for recording speeches from speakers when the meeting is going on; a speech segmentation means 220 for receiving a speech stream from the speech recorder 210 and automatically dividing the speech stream into several speech chunks (at least two speech chunks) by using an appropriate segmentation algorithm as described above; a graphical user interface (GUI) 230 for receiving all the contents (including the text content) input by a user through an inputting means (not shown), and displaying the received contents and the divided speech chunks; a speech chunk manager 240 for receiving the speech chunks and providing them to the GUI 230 for browsing and navigation purpose; and a voice tagger 250 for correlating (tagging) the user's inputs (i.e., text note points) obtained by the GUI 230 with the speech chunks sent from the speech chunk manager 240, making the speech stream, the text information and its corresponding tagging relation form the voice tagged meeting minutes.

In addition, the system of the present invention can further comprise a control means (such as a CPU or the like, which is not shown) for controlling the operation of the whole system.

The user writes text note points on the editing area of the GUI 230 through an inputting means (such as a keyboard, a mouse, a handwriting board or the like, which is not shown), and when the user attaches the speech chunks to the note points by using the drag-and-drop method on the GUI 230, the voice tagger 250 obtains the command of the above operations from the GUI 230 (or other means such as a controller), and conducts the operation of performing correlation process on the note points and the speech chunks.

Correlating the note points (text information) with the speech chunks, i.e., the operation of establishing the tagging between them is a technology well known by those skilled in the art, which will not be described further here.

In addition, the present invention is not limited to a fact that the above mentioned components implement corresponding operations independently, they can also be implemented into less components or only one component, as known by those skilled in the art. For example, the GUI 230, the speech chunk manager 240 and the voice tagger 250 therein are implemented as a meeting minutes generating means 260, and so on.

In addition, the system of the present invention further comprises: a meeting minutes repository 270 for saving the generated voice tagged meeting minutes (including the speech stream, the corresponding text information and the corresponding tagging relations); and a minutes reviewing means 280 for obtaining the saved voice tagged meeting minutes from the meeting minutes repository 270, and providing the GUI used by the user with the voice tagged meeting minutes, so as for the user to read the meeting minutes and listen to the tagged voice record through a sound reproducing means (such as a loudspeaker) in the minutes reviewing means 280.

According to one aspect of the present invention, the above mentioned means, i.e., the speech recorder 210, the speech segmentation means 220, the meeting minutes generating means 260 (or the GUI 230, the speech chunk manager 240 and the voice tagger 250), the meeting minutes repository 270 and the minutes reviewing means 280, can be implemented into a single apparatus such as a personal computer.

According to another aspect of the present invention, the above mentioned means can also be implemented in different apparatuses. For example, the speech recorder 210, the speech segmentation means 220, the meeting minutes generating means 260 (or the GUI 230, the speech chunk manager 240 and the voice tagger 250) can be implemented in a single apparatus as a recording (generating) apparatus, while the meeting minutes repository 270 and the minutes reviewing means 280 can be implemented in another single apparatus as a reproducing apparatus.

Of course, only the meeting minutes generating means 260 or the GUI 230 and the voice tagger 250 can be implemented as a single recording apparatus, the speech recorder 210 and/or the speech segmentation means 220 can be implemented as an input apparatus, and the meeting minutes repository 270 and the minutes reviewing means 280 can be implemented in another single apparatus as a reproducing apparatus. Alternatively, according to the embodiment, the meeting minutes repository 270 can also be implemented in the above mentioned recording apparatus, while only the minutes reviewing means 280 is implemented in another single apparatus as a reproducing apparatus.

Those skilled in the art should be able to implement various changes according to the above description, which will not be described here one by one.

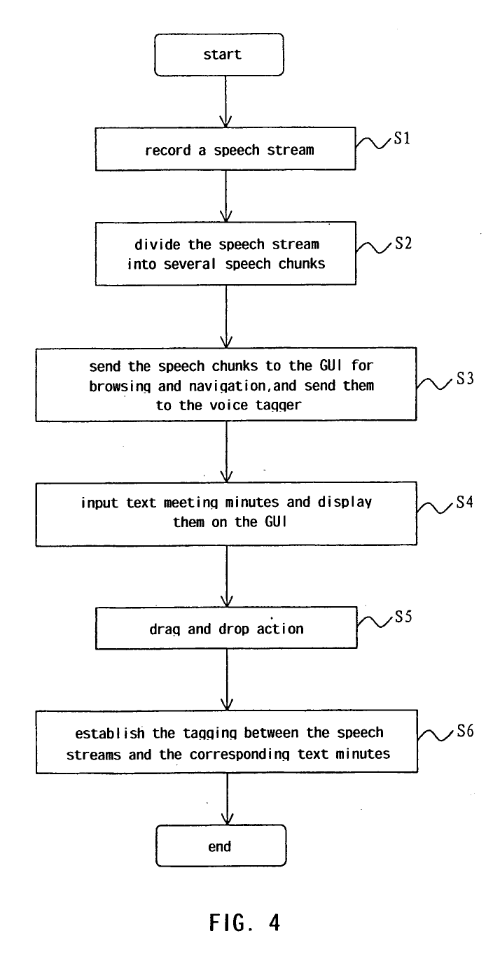

The specific operations of the system according to the present invention will be described hereinafter in conjunction with FIGS. 4-7.

FIG. 4 shows a flow chart of the process performed according to the present invention.

As shown in FIG. 4, at step S1, when the meeting is going on, the speech stream is recorded by using the speech recorder 210 of the present invention on its speech recording tracks, and sent to the speech segmentation means 220. At step S2, the speech segmentation means 220 divides the speech stream into several speech chunks, and sends the speech chunks to the speech chunk manager 240. At step S3, the speech chunk manager 240 sends the divided speech chunks to the GUI 230, and displays them thereon for browsing and navigation purpose. In the same time, the speech chunk manager 240 also sends the divided speech chunks to the voice tagger 250 for subsequent operations.

At step S4, the meeting logger writes meeting minutes (as shown by the lower block in FIG. 2) on the GUI by using an inputting means (not shown). At step S5, the status signs of the speech chunks are dragged and dropped onto the corresponding note points. At step S6, the voice tagger 250 receives a command that the user drags and drops each of the status signs of the speech stream chunks onto the corresponding text information on the GUI, and establishes the tagging relation between each speech stream chunk and its corresponding text information, such that the speech stream, the text information and the corresponding tagging relation form the voice tagged meeting minutes.

In this way, according to the method, apparatus and system of the present invention, the divided speech chunks are correlated with the corresponding minutes by using the drag-and-drop technology, to generate a full voice tagged meeting minutes.

The above steps of the present invention is not limited to being performed in the above sequence, and can be performed in other sequences or simultaneously. For example, the step S1 for recording speeches and the step S4 for recording the text meeting minutes can be performed simultaneously and so on.

In addition, the generated voice tagged meeting minutes of the present invention can also be saved in the meeting minutes repository 270. When the reader wants to read the meeting minutes, he can take the saved voice tagged meeting minutes from the meeting minutes repository 270 by using the minutes reviewing means 280, and clicks on the interested text minutes (note points) displayed on the GUI. Thus the reader can listen to the voice record related to the interested note points.

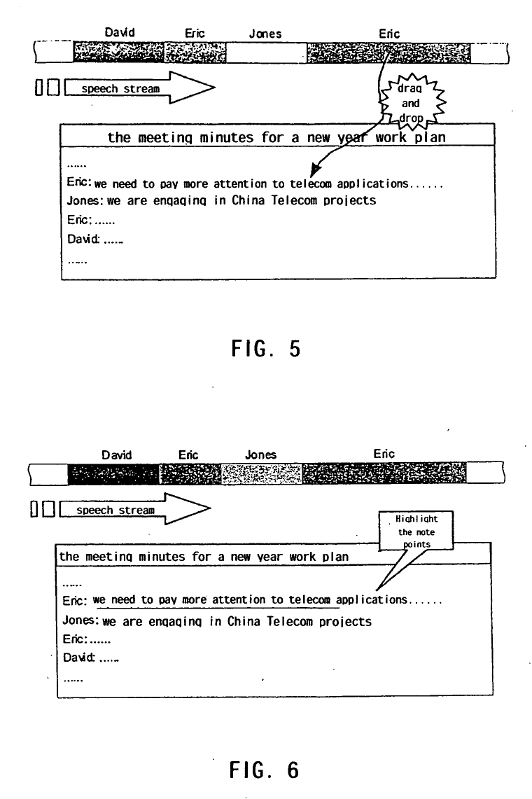

FIG. 5 shows how to stick a piece of speech chunk with a specific note point in the text minutes. As shown by the curves and arrows in the Figure, by using a device such as a mouse, the status sign indicating the speech chunk of Eric's speaking is dragged and dropped onto an Eric's text minute (i.e. Eric: we need to pay more attention to the telecom applications) located on the lower part of the GUI. This is an easy drag-and-drop action.

FIG. 6 indicates that after the drag-and-drop action, the note point is highlighted and looks like a HTML link. The highlighted part is shown in the Figure. In addition, this kind of correlation can also be shown in other manners, such as a small icon displayed behind the text information. When a piece of text information correlates with several speech chunks, this can be represented by one or more small icons. When the meeting minutes are being read, the voice clips can be played by simply clicking on the small icons.

FIG. 7 depicts a case of the playing time of the meeting minutes. When a reader wants to read the meeting minutes, he can click on the highlighted note points by a device such as a mouse, and then he can listen to the related voice record of each note point in the meeting minutes.

In conclusion, the main content of the apparatus and method of the present invention is as follows: the speech segmentation means 220 divides a speech stream input from outside into at least two chunks, the status sign of each speech stream chunk and the text information input by the user through an inputting means (not shown) are displayed on the GUI 230, and when the voice tagger 250 receives a command that a user drags and drops the status signs of the respective speech stream chunks onto the corresponding text information on the GUI 230, the tagging between each speech stream chunk and the corresponding text information is established so as to generate the voice tagged meeting minutes.

The method, apparatus and system of the present invention facilitate recording and reviewing the meeting minutes, improve its readability and usability, and provide users with both the text minutes and the indexed and segmented voice meeting minutes.

The method, apparatus and system of the present invention will bring great improvement to our daily business meetings. It will not only increase the efficiency of people who take notes at the meeting, but also bring significant benefit to those people who did not attend the meeting, but want to get the content of the meeting.

While the present invention has been described in details for clearly understanding purpose, the current embodiment is only illustrative and not restrictive. Obviously, those skilled in the art can make appropriate amendments and replacements on the present invention without departing from the spirit and scope of the present invention.

What is claimed is:

1. A method for generating speech minutes, the method comprising the steps of:
displaying status indicators of respective audio stream chunks inputted from outside and text information thereof on a GUI display;
establishing a tagging relation between each audio stream chunk and corresponding text information, such that the audio stream, the text information and the corresponding tagging relation form voice tagged meeting minutes.

2. The method according to claim 1, wherein the tagging is established by dragging and dropping the status indicators of the respective audio stream chunks onto the corresponding text information on the GUI.

3. A method for generating speech minutes, comprising the steps of:
dividing a audio stream inputted from outside into at least two chunks and displaying a status sign of each audio stream chunk and text information thereof on a GUI; and
establishing the tagging between each audio stream chunk and the corresponding text information, such that the audio stream, the text information and the corresponding tagging relation form voice tagged meeting minutes.

4. The method according to claim 3, wherein the tagging is established by dragging and dropping the status indicators of the respective audio stream chunks onto the corresponding text information on the GUI.

5. The method according to claim 4, further comprising the step of: continuously recording and displaying the status sign of each audio stream chunk according to the development of the audio stream, wherein said status sign indicating the length and/or the type of the audio stream.

6. The method according to claim 5, wherein the status sign is a bar displayed in different colors or different brightness.

7. The method according to claim 3, further comprising the step of: the text information is inputted from outside as the text minutes of the audio stream.

8. An apparatus for generating speech minutes, comprising:
a GUI for displaying status indicators of respective audio stream chunks inputted from outside and text information thereof; and
a speech tagging means for establishing the tagging between each audio stream chunk and the corresponding text information, such that the audio stream, the text information and the corresponding tagging relation form voice tagged meeting minutes.

9. The apparatus according to claim 8, wherein when receiving a command of dragging and dropping the status indicators of the respective audio stream chunks onto the corresponding text information on the GUI, the speech tagging means establishes the tagging.

10. The apparatus according to claim 8, further comprising a speech segmentation means for dividing an audio stream inputted from outside into at least two chunks;

11. The apparatus according to claim 10, further comprising:
a speech recording means for recording a speech of a speaker, and continuously displaying the status sign of each audio stream chunk on the GUI according to the development of the audio stream, wherein the status sign indicating the length and/or the type of the audio stream.

12. The apparatus according to claim 10, further comprising:
an inputting means by which a user inputs the text information as the text minutes of the audio stream.

13. The apparatus according to claim 10, further comprising:
a meeting minutes repository for saving the generated voice tagged meeting minutes; and
a minutes browsing means for providing the voice tagged meeting minutes from the meeting minutes repository to the GUI, so as for the user to read the meeting minutes and listen to the tagged speech record.

14. A system for generating speech minutes, the system comprising a recording device and a reproducing device, wherein the recording device comprises:
a speech segmentation means for dividing a audio stream inputted from outside into at least two chunks;
a first GUI for displaying status indicators of respective audio stream chunks and the text information thereof; and
a speech tagging means for establishing the tagging between each audio stream chunk and the corresponding text information when receiving a command of dragging and dropping the status indicators of the respective audio stream chunks onto the corresponding text information on the GUI, such that the audio stream, the text information and the corresponding tagging relation form voice tagged meeting minutes.

15. The system according to claim 14, wherein the recording device further comprises:
a speech recorder for recording a speech of a speaker, and continuously displaying the status sign of each audio stream chunk on the first GUI according to the development of the audio stream.

16. The system according to claim 14, wherein the recording device further comprises:
an inputting means by which a user inputs the text information as the text minutes of the audio stream.

17. The system according to claim 14, wherein the recording device further comprises:
a meeting minutes repository for saving the generated voice tagged meeting minutes.

18. The system according to claim 17, wherein the reproducing device comprises:
a second GUI for displaying the voice tagged meeting minutes; and
a minutes browsing means for providing the voice tagged meeting minutes from the meeting minutes repository to the second GUI, so as for the user to read the meeting minutes and listen to the tagged speech record.
